(19) United States
(12) Patent Application Publication
(10) Pub. No.: US 2017/0111449 A1
(43) Pub. Date: Apr. 20, 2017

(54) SYNCHRONIZATION OF AN ORDER OF ACCESS INSTRUCTIONS FROM A PRIMARY COMPUTING ENVIRONMENT TO A REPLICATED COMPUTING ENVIRONMENT

(71) Applicant: CloudEndure Ltd., Ramat Gan (IL)

(72) Inventors: Ophir SETTER, Ramat Gan (IL); Ofir Ehrlich, Netanya (IL); Leonid FEINBERG, Ramat HaSharon (IL)

(73) Assignee: CloudEndure Ltd., Ramat Gan (IL)

(21) Appl. No.: 15/395,601

(22) Filed: Dec. 30, 2016

Related U.S. Application Data
(63) Continuation-in-part of application No. 15/196,899, filed on Jun. 29, 2016.
Application No. 15/196,899 is a continuation-in-part of application No. 14/870,652, filed on Sep. 30, 2015.
Application No. 14/870,652 is a continuation-in-part of application No. 14/205,083, filed on Mar. 11, 2014, now Pat. No. 9,582,386.
(60) Provisional application No. 62/429,786, filed on Dec. 3, 2016.
(60) Provisional application No. 62/273,806, filed on Dec. 31, 2015.
(60) Provisional application No. 61/787,178, filed on Mar. 15, 2013.

(51) Int. Cl. H04L 29/08; G06F 1/12

(52) U.S. Cl. CPC H04L 67/1095; G06F 1/12

(57) ABSTRACT

A method and system for synchronizing an order of access instructions from a primary computing environment to a replicated computing environment. The method comprises detecting at least one access instruction to at least a disk of a primary machine in the primary computing environment; updating a state of a first logical clock structure (LCS) maintained by the primary machine, wherein the first LCS includes a plurality of elements, wherein each of the plurality elements is associated with a distinct primary machine in a primary computing environment, wherein each element in the first LCS is updated based on the at least one detected access instruction; and sending the access instruction and a current state of the first LCS to a corresponding replicated machine in a replicated computing environment, thereby allowing the corresponding replicated machine to determine the causal order of access instructions based in part on the first LCS.

### CROSS-REFERENCE TO RELATED APPLICATIONS

This application claims the benefit of U.S. Provisional Application No. 62/429,786 filed on Dec. 3, 2016. This application is also a continuation-in-part of: a) U.S. patent applicant Ser. No. 15/196,899 filed Jun. 29, 2016, now pending, which claims priority from U.S. Provisional Patent Application No. 62/273,806 filed Dec. 31, 2015; b) U.S. patent application Ser. No. 14/870,652 filed Sep. 30, 2015, now pending; and c) a) U.S. patent application Ser. No. 14/205,083 filed Mar. 11, 2014, now allowed, which claims priority from U.S. Provisional Patent Application No. 61/787,178 filed Mar. 15, 2013, all the above-mentioned applications are incorporated herein by reference.

### TECHNICAL FIELD

The disclosure generally relates to replicating machines from a first computing environment to a second computing environment, and particularly to synchronizing events from the first computing environment in the second computing environment.

### BACKGROUND

Computer servers provide access to a plethora of services, many of which are supplied over a network and on-demand in a cloud computing environment. In general, cloud computing environments allow for developing scalable applications in which computing resources are utilized to support efficient execution of the applications.

Organizations and businesses that develop, provide, or otherwise maintain cloud-based applications have become accustomed to relying on these services and implementing various types of environments, from complex web sites to data mining systems and much more. However, there is a challenge as greater reliance is made on such systems, since such systems have to maintain a very high up-time and any failure may become highly problematic and/or costly to a user of the system. That is, there is a requirement to allow for business continuity. For example, for an e-commerce application executed in a cloud-based environment, any downtime of such application means revenue and/or good will lost. As a result, providers of such applications often utilize measures to ensure continuity of operations by backing up information that is relevant to maintaining operations.

Various solutions for restoring and replicating machines from a networked computer environment are known in the art. For example, some solutions may attempt to initialize a replicated machine in place of an original machine. A machine can be a physical machine (e.g., a server) or a virtual machine hosted by a physical machine. One problem faced by such solutions is that there may be significant down time when switching from the original machine to the replicated machine, and then again when switching back to operating with the original machine after data has accumulated in the replicated machine which does not exist in the original machine.

Another problem faced by solutions for restoring and replicating machines is with keeping the order of events when replicating machines. For example, when a plurality of devices write to a database and the database is physically stored on more than one physical disk (which may be distributed across a plurality of physical servers), discrepancies may arise as to when each write was performed.

This may be solved, for example, by having a timestamp server, which issues a timestamp to each instruction sent over the network or performed locally on the machine. However, this timestamp saver typically creates a bottleneck and latency issues, and is therefore an ineffective solution at scale. Another conventional approach for tracking the order of events is synchronizing each machine with a single clock. However, such an approach is inefficient when implemented in large computing environments, where operations or events happen at a rate faster than which the elements may be synchronized without again creating bottleneck and latency issues.

It would be advantageous to provide a solution to improve or overcome the deficiencies the noted above.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Some embodiments disclosed herein include a method for synchronizing an order of access instructions from a primary computing environment to a replicated computing environment. The method comprises detecting at least one access instruction to at least a disk of a primary machine in the primary computing environment; updating a state of a first logical clock structure (LCS) maintained by the primary machine, wherein the first LCS includes a plurality of elements, wherein each of the plurality elements is associated with a distinct primary machine in a primary computing environment, wherein each element in the first LCS is updated based on the at least one detected access instruction; and sending the access instruction and a current state of the first LCS to a corresponding replicated machine in a replicated computing environment, thereby allowing the corresponding replicated machine to determine the causal order of access instructions based in part on the first LCS.

Some embodiments disclosed herein also include a system for synchronizing an order of access instructions from a primary computing environment to a replicated computing environment. The system comprises a processing circuitry; and a memory communicatively connected to the processing system, the memory containing instructions that, when executed by the processing circuitry, configure the system to: detect at least one access instruction to at least a disk of a primary machine in the primary computing environment; update a state of a first logical clock structure (LCS) maintained by the primary machine, wherein the first LCS includes a plurality of elements, wherein each of the plurality elements is associated with a distinct primary machine in a primary computing environment, wherein each element in the first LCS is updated based on the at least one detected access instruction; and send the access instruction and a current state of the first LCS to a corresponding replicated machine in a replicated computing environment, thereby allowing the corresponding replicated machine to determine the causal order of access instructions based in part on the first LCS.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1A is a schematic illustration of a primary machine configured to perform the various disclosed embodiments.

FIG. 1B is a block diagram of the primary machine utilized to carry out the disclosed embodiments.

FIG. 2 is a schematic illustration of a plurality of primary machines and their replicated counterparts operating within a network environment, implemented in accordance with an embodiment.

FIG. 3 is a flowchart of a method for replicating a primary machine from a primary computing environment to a replicated computing environment, implemented in accordance with an embodiment.

FIG. 4 is a flowchart of a method for determining an order in which to execute access instructions originating from a primary machine in a primary computing environment on a replicated machine in a replicated computing environment, according to an embodiment.

FIG. 5 is an example vector clock utilized to maintain a current state of access instructions according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claims. Moreover, some statements may apply to some inventive features but not to others. In general, unless otherwise indicated, singular elements may be in plural and vice versa with no loss of generality.

According to some example embodiments, in order to replicate a computing environment, each access instruction to a shared, and/or distributed, resource (e.g., disk) of the primary machine is monitored. Due to the nature of networks, access instructions may arrive at the replicated environment at an order that is different from the order of the original computing environment. For example, if an object is first written to a disk of the primary machine and then the object is erased, the order of access instructions as received at the replicated machine may be reserved (erase and then write). According to the disclosed embodiment, a vector clock in each primary machine is updated when an access instruction is detected. The correct execution order of access instructions in the replicated environment is determined based on the causality among a plurality of vector clocks.

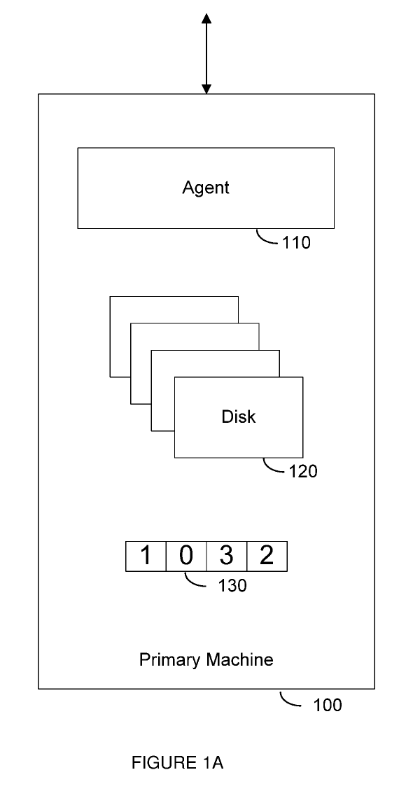

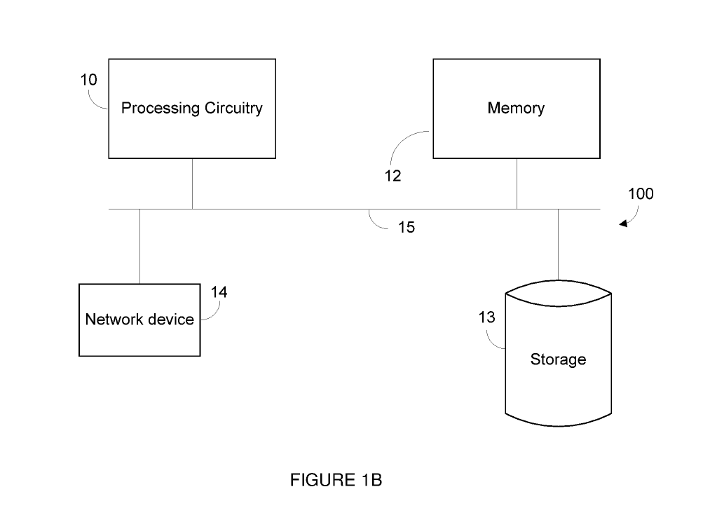

FIG. 1A is an example illustration of a primary machine 100 configured to perform the various disclosed embodiments. The primary machine 100 includes an agent 110, and a disk 120. In some embodiments, the disk 120 may be a plurality of disks. The plurality of disks may include one or more data disks, a root disk, a boot disk or any combination thereof, implemented on one or more logical drives or physical disks. A portion of the disk 120 may be hard drives, solid state drives, network accessible storages, and the like.

In certain embodiments, the primary machine 100 may be a server, a physical machine, a virtual machine, one or more services, and the like. A physical machine or a virtual instance thereof may be, for example, a web server, a database server, a cache server, a virtual appliance, or a combination thereof. A service may be a network architecture management service, a load balancing service, an auto scaling service, a content delivery network (CDN) service, a network addresses allocation service, a database service, a domain name system (DNS) service, and the like. An example block-diagram of the primary machine 100-1 is shown in FIG. 1B.

In an embodiment, the agent 110 is configured to monitor any access to at least the disk 120. The agent 110 may be realized as a software application, an operating system service, a software container, a script, and the like. In an embodiment, the agent 110 may be a software module configured to communicate with the primary machine. For example, the agent may run on, or be communicatively connected with, a host operating system running a hypervisor, the hypervisor hosting the primary machine 100.

It should be appreciated that software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry, causes the processing circuitry to perform the various functions that the agent 110 is configured to perform as described in further detail herein.

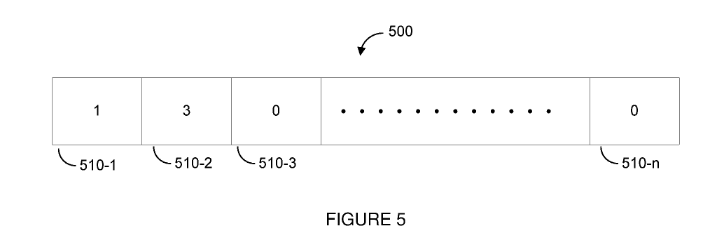

In an embodiment, the primary machine 100 further includes a vector clock 130 stored therein. The vector clock may be stored, for example, in a memory, or storage, of the primary machine 100. It should be noted that each primary machine in a primary computing environment maintains its own vector clock. An example diagram of a vector clock is provided in FIG. 5.

In an embodiment, the vector clock 130 includes a plurality of elements, each element corresponding to a machine, or node, in a primary computing environment in which the primary machine 100 is implemented in. The vector clock 130 includes 4 elements in this example embodiment. Each element is incremented by the machine, or node, to which it corresponds. When, e.g., a first machine receives a vector clock from, e.g., a second machine, corresponding elements may be compared to generate an updated vector clock including the highest value for each element. Thus, the updated vector clock includes the current state of each of the nodes, as is known at a given point in time. In an embodiment, each element maintains an integer value. In some embodiments, a coded value can be maintained by each element, where such a coded value may be a function of a current timestamp, an integer, a machine's ID, and so on, or any combination thereof.

In this example embodiment, a vector clock is used to determine an event order in a distributed system. However, it should be appreciated that other types pf logical clock structures (LCSs) can be used without departing from the scope of the disclosed embodiments. Examples for such a LCS may include a Lamport timestamp, a matrix clock, a version vector, and the like, or combinations thereof.

FIG. 1B is an example block diagram of the primary machine 100 utilized to carry out the disclosed embodiments. The primary machine 100 includes at least one processing circuitry 10. In an embodiment, the processing circuitry 10 includes, or is a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

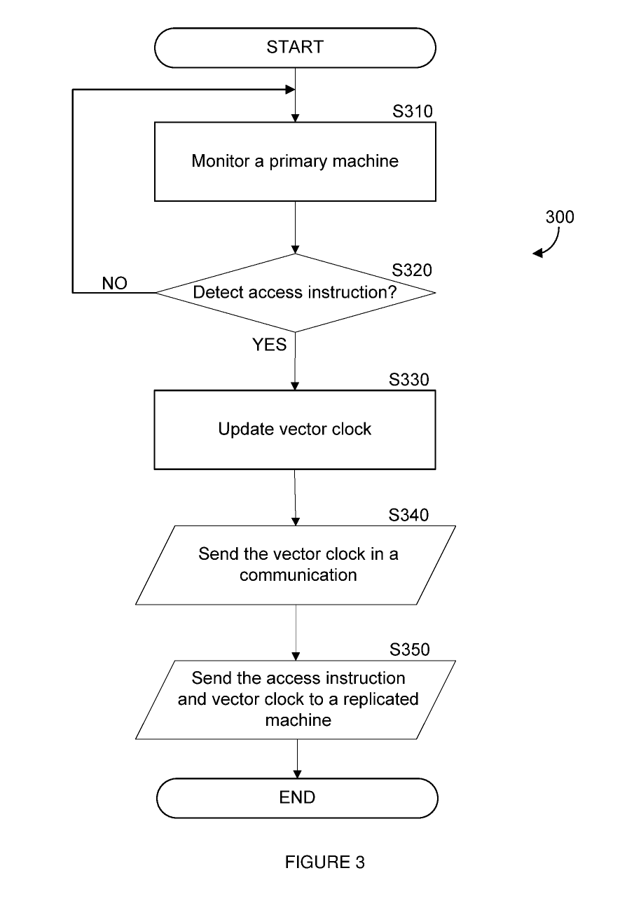

The processing circuitry 10 is coupled via a bus 15 to a memory 12. The memory 12 further includes instructions that, when executed by the processing circuitry 10, performs the restoration method described in more detail with reference to FIG. 3 below. The memory 12 may be a volatile memory such as, but not limited to random access memory (RAM), or non-volatile memory (NVM), such as, but not limited to, Flash memory. The memory 12 may contain the vector clock of the primary machine.

The processing circuitry 10 may be coupled to a network interface 14, for providing connectivity between to other primary machines, a server, or replicated machines. The processing circuitry 10 may be further coupled with a storage 13. The storage 13 may be the disk accessed by the primary machines (e.g., the disk 120).

The processing circuitry 10, the memory 15, or both may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described in further detail herein.

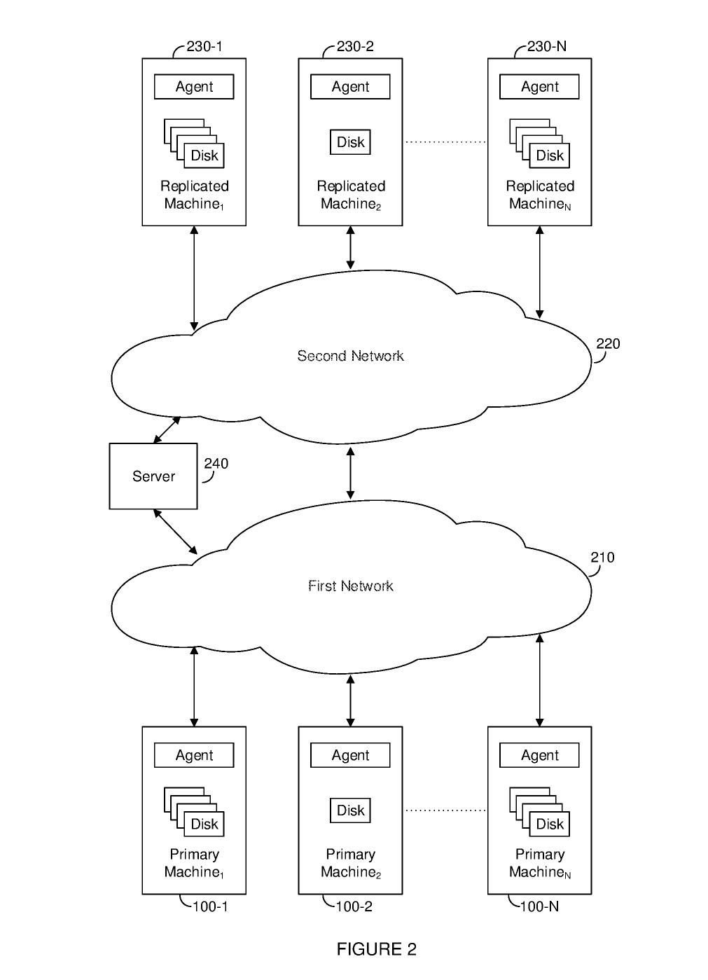

FIG. 2 is an example schematic illustration of a plurality of primary machines 100-1 through 100-N and their replicated counterparts operating within a network environment, and implemented according to an embodiment. A server 240 is communicatively connected with a first network 210, which provides connectivity for a primary computing environment. The server 240 may be configured to install an agent, such as the agent 110, on each primary machine 100-1 through 100-N.

The first network 210 is configured to provide connectivity of various sorts, as may be necessary, including but not limited to, wired connectivity, wireless connectivity, or both, including, for example, a local area network (LAN), a wide area network (WAN), a metro area network (MAN), the worldwide web (WWW), the Internet, and any combination thereof, as well as cellular connectivity.

The network 210 may include a virtual private network (VPN). The primary machines 100-1 through 100-N are communicatively connected to the first network 210 and comprise together the primary computing environment. A primary machine 100 may be a server, a physical machine, virtual machine, services and the like. A physical/virtual machine may be, for example, a web server, a database server, a cache server and virtual appliances. A service may be a network architecture management service, a load balancing service, an auto scaling service, a content delivery network (CDN) service, a network addresses allocation service, a database service, a domain name system (DNS) service, and the like.

The server 240 is further communicatively connected to a second network 220, which provides connectivity for a replicated computing environment, to which the primary computing environment may be replicated. The second network 220 is configured to provide connectivity of various sorts, as may be necessary, including but not limited to, wired connectivity, wireless connectivity, or both, including, for example, a LAN, a WAN, a MAN, the worldwide web (WWW), the Internet, and any combination thereof, as well as cellular connectivity.

Replicated machines 230-1 through 230-N, each correspond to a primary machine 100, such that Replicated Machine₁ (230-1) corresponds to Primary Machine₁ (100-1), and generally Replicated Machineᵢ to Primary Machineᵢ, where ‘N’ is a natural integer having a value of ‘1’ or greater and ‘i’ having a value of ‘1’ through ‘N’. The replicated machines 230 are each communicatively connected to the second network 220. In an embodiment where network 210 or network 220 include a VPN, a portion or all of the machines may be included in the VPN. In certain embodiments, the primary computing environment and the replicated computing environment may be one computing environment.

FIG. 3 is an example flowchart 300 of a method for synchronizing order of access instructions from a primary computing environment to a replicated computing environment according to an embodiment.

At S310, a primary machine in the primary computing environment is monitored. Specifically, the primary machine is monitored to detect an access instruction to a resource (e.g., the disk of the primary machine). The resource may be shared among other machines in the primary computing environment. It should be noted that such a resource may be a distributed resource. For example, a logical disk may include a plurality of physical disks, where one or more of the physical disks are attached to a first machine, and one or more physical disks are attached to another machine. An access instruction may be, for example, a read, write, trim, or erase instruction.

At S320 it is checked if an access instruction is detected. If so, execution continues with S330; otherwise, execution returns to S310. At S330, a vector clock in the primary machine is updated. Specifically, an element corresponding to the particular primary machine is updated. The update may include, for example, incrementing the element' value. In certain embodiments, an element of the vector clock may correspond to a resource of the primary machine. In some embodiment, some elements may correspond to machines, and some may correspond to resources of the machines.

As illustrated in FIG. 5, a vector clock 500 includes a plurality of elements 510-1 through 510-n, each corresponding to a machine (e.g., the primary machines 100-1 through 100-N, FIG. 2) in the primary computing environment. Each element 510 maintains a clock value. The clock value may be, for example, an integer number or a coded value as discussed above. At initial deployment, typically all clock values in the elements 510-1 through 510-n are set to zero, or to some other predetermined value. Each element is updated when a respective access instruction is detected.

For example, if the primary machine (100-1, FIG. 2) being monitored is associated with element 510-1, then upon detection of an access instruction to the disk of the machine (100-1), the clock value of element 510-1 is incremented.

It should be noted that each primary machine maintains its own vector clock and, thus, there are N vector clocks. As noted above, in some embodiments, an element may correspond to a component (or resource) of a machine, such as a storage device, for example.

Returning in FIG. 3, at S340, the updated vector clock is sent by the primary machine. In some embodiments, the vector clock may be sent to the server (e.g., the server 240), the corresponding replicated machine, or a secondary machine.

In an embodiment, the vector clock is sent when the vector clock is updated. In another embodiment, the vector clock of the primary machine is sent with each communication between the primary machine and at least another primary machine in the primary computing environment. Alternatively, the vector clock of the primary machine is sent with any outgoing communication from the primary machine, regardless of whether the vector has changed since the last time the vector was sent and of the destination of the vector. While the frequency of sending the vector clock may be reduced in some embodiments, this may lead to a loss in the ability to later reconstruct and ordering of events.

In some embodiments, the vector clock may be embedded, for example, within a TCP/IP packet. In some embodiments, the first vector clock is sent with each outgoing communication from the primary machine, regardless of whether the vector has changed since the last time it was sent, and regardless of the machine to which it is being sent.

At S350, the access instruction and the vector clock of the primary machine are sent to a corresponding replicated machine in the replicated computing environment.

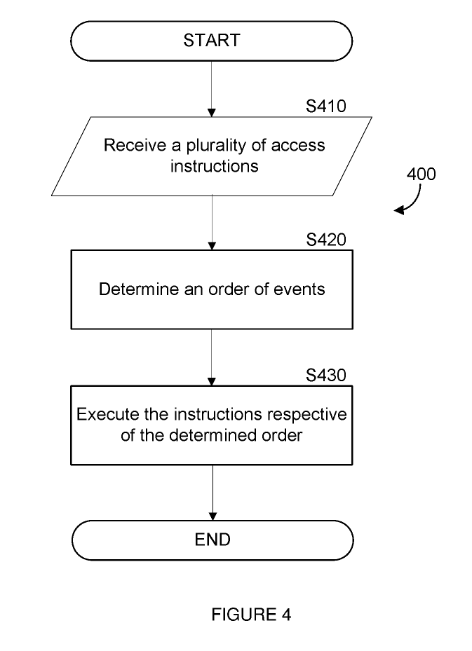

FIG. 4 is an example flowchart 400 of a method for determining an order in which to execute access instructions originating from a primary machine in a primary computing environment on a replicated machine in a replicated computing environment according to embodiment.

At S410, a plurality of access instructions and their corresponding vector clocks are received. The access instructions may not be received at the same time. The access instructions may originate from the same primary machine, and should be executed on the corresponding replicated machine, so that each replicated machine is an up to date replica of the primary machine. For example, for first and second access instructions originating at the primary machine 100-1, the replicated machine 230-1 should receive and execute the first and second access instructions in that order.

However, as the primary machine may be distributed, the access instructions may not arrive in the order in which they were executed on the primary machine. The order of the access instructions may be crucial. For example, when executing an ‘erase’ instruction and a ‘write’ instruction respective of the same address, the result may be very different according to the order in which the instructions are executed.

At S420, an order of access instructions is determined based on the causality between the plurality of vector clocks. The following example demonstrates the operation of S420. A primary computing environment includes primary machines (100-1 and 100-2, FIG. 2). The first element (510-1, FIG. 5) of the vector clock is associated with the primary machine 100-1, and the second element (510-2, FIG. 5) of the vector clock is associated with the primary machine 100-2.

A replicated machine (230-2, FIG. 2) in the replicated computing environment corresponding to the primary machine 100-2 receives a first vector clock and a second vector clock from the primary machine 110-2. The first vector clock may be (1,1) and the second vector clock may be (1,0). This would indicate that the second access instruction (associated with second vector) occurred before the first access instruction (associated with first vector). In another example, the first vector clock may be (2,1) and the second vector clock may be (0,1). In this case, there is no determinable causality between the first and second access instructions, so the order of their execution does not matter.

At S430, the access instructions are executed in the determined order of access. In some cases, there may be determined that no causality exists between access instructions, thus the access instructions may be executed for example, in the order in which they were received.

In some embodiments, the primary machine (e.g., the primary machine 100-1) may receive a current state of a vector clock of another machine (e.g., machine 100-n) in the primary computing environment. Upon determination that the element corresponding to the other machine 100-n was updated more recently in the received vector clock, the primary machine updates the element corresponding to the other machine (e.g., element 510-2) in its vector clock.

Throughout this disclosure, discussion has centered on a vector clock algorithm utilized to generate an order of events respective of access instructions. However, it should be appreciated that there are alternative methods for providing ordering of events in a distributed computer system, which may be implemented without departing from the scope of this disclosure. Such non-limiting examples may be Lamport timestamps, matrix clocks, version vectors, and the like. Combinations of such systems may also be utilized.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. For the purpose of this disclosure, the terms ‘machine’ and ‘component’ are used interchangeably.

What is claimed is:

1. A method for synchronizing an order of access instructions from a primary computing environment to a replicated computing environment, comprising:
detecting at least one access instruction to at least a disk of a primary machine in the primary computing environment;
updating a state of a first logical clock structure (LCS) maintained by the primary machine, wherein the first LCS includes a plurality of elements, wherein each of the plurality elements is associated with a distinct primary machine in a primary computing environment, wherein each element in the first LCS is updated based on the at least one detected access instruction; and
sending the access instruction and a current state of the first LCS to a corresponding replicated machine in a replicated computing environment, thereby allowing the corresponding replicated machine to determine the causal order of access instructions based in part on the first LCS.

2. The method of claim 1, further comprising:
monitoring any access to the disk of the primary machine, wherein the disk can be accessed by at least one other primary machine in the replicated computing environment.

3. The method of claim 2, wherein the monitoring is performed by an agent installed on the primary machine.

4. The method of claim 1, further comprising:
sending the updated state of the first LCS to at least one of: the replicated machine, a server communicatively connected to the respective replicated machine, and a secondary machine.

5. The method of claim 1, wherein the first LCS is at least a vector clock.

6. The method of claim 1, wherein updating the state of the first LCS further comprises:
incrementing a value of the respective element upon detection of the access instruction.

7. The method of claim 1, wherein the access instruction is any one of: read, write, trim, and erase.

8. The method of claim 1, further comprising:
receiving, in the replicated computing environment, a plurality of access instructions with their corresponding LCS states; and
determining based on the LCS states, a causal order of the plurality of access instructions.

9. The method of claim 8, further comprising:
executing the access instructions based on the determined causal order.

10. A non-transitory computer readable medium having stored thereon instructions for synchronizing an order of access instructions from a primary computing environment to a replicated computing environment, the process comprising:
detecting at least one access instruction to at least a disk of a primary machine in the primary computing environment;
updating a state of a first logical clock structure (LCS) maintained by the primary machine, wherein the first LCS includes a plurality of elements, wherein each of the plurality elements is associated with a distinct primary machine in a primary computing environment, wherein each element in the first LCS is updated based on the at least one detected access instruction; and
sending the access instruction and a current state of the first LCS to a corresponding replicated machine in a replicated computing environment, thereby allowing the corresponding replicated machine to determine the causal order of access instructions based in part on the first LCS.

11. A system for synchronizing an order of access instructions from a primary computing environment to a replicated computing environment, comprising:
a processing circuitry; and
a memory communicatively connected to the processing system, the memory containing instructions that, when executed by the processing circuitry, configure the system to:
detect at least one access instruction to at least a disk of a primary machine in the primary computing environment;
update a state of a first logical clock structure (LCS) maintained by the primary machine, wherein the first LCS includes a plurality of elements, wherein each of the plurality elements is associated with a distinct primary machine in a primary computing environment, wherein each element in the first LCS is updated based on the at least one detected access instruction; and
send the access instruction and a current state of the first LCS to a corresponding replicated machine in a replicated computing environment, thereby allowing the corresponding replicated machine to determine the causal order of access instructions based in part on the first LCS.

12. The system of claim 11, wherein the system is further configured:
monitor any access to the disk of the primary machine, wherein the disk can be accessed by at least one other primary machine in the replicated computing environment.

13. The system of claim 12, wherein the monitoring is performed by an agent installed on the primary machine.

14. The system of claim 11, wherein the system is further configured:
send the updated state of the first LCS to at least one of: the replicated machine, a server communicatively connected to the respective replicated machine, and a secondary machine.

15. The system of claim 11, wherein the first LCS is at least a vector clock.

16. The system of claim 11, wherein the system is further configured:
increment a value of the respective element upon detection of the access instruction.

17. The system of claim 11, wherein the access instruction is any one of: read, write, trim, and erase.

18. The system of claim 11, wherein the system is further configured:
receive, in the replicated computing environment, a plurality of access instructions with their corresponding LCS states; and
determine based on the LCS states, a causal order of the plurality of access instructions.

19. The system of claim 18, wherein the system is further configured:
execute the access instructions based on the determined causal order.
